(19) United States
(12) Patent Application Publication
(10) Pub. No.: US 2008/0052314 A1
(43) Pub. Date: Feb. 28, 2008

(54) e-ENABLER FRAMEWORK

(76) Inventor: Ritwik Batabyal, Bangalore (IN)

Correspondence Address: Global IP Services, PLLC;198 F, 27th Cross,3rd Block, Jayanagar, Bangalore, Karnataka, 560011, omitted

(21) Appl. No.: 11/467,175

(22) Filed: Aug. 25, 2006

(51) Int. Cl. G06F 17/00

(52) U.S. Cl. 707/104.1

(57) ABSTRACT

A system and application design paradigm in the form of web-architecture, uses self describing modules of reusable services, offering SOA (Service Oriented Architecture) based composite solutions and multiple processes in a dynamic business environment. The system is termed e-Enabler Framework, and in one form, includes three frameworks, i.e., web processing framework, business logic framework and a data access framework (termed herein as persistence framework). Each of the three frameworks may include sub-frameworks with specific functionalities. The e-Enabler Framework provides a multiplicity of infrastructure services including: Logging Service, Security Service, Notification Service, (Exception Service), Caching Service, Session Management Service and, Internationalization Service. The e-Enabler Framework in a preferred form also includes a plurality of plug-in modules for performing different functions, and is capable of being used on different platforms including. BEA®, IBM®, SAP®, JBoss® Application Server, Oracle® Application Server, and SUN® Application Server.

### RELATED APPLICATIONS

This application is related to co-pending US application, with the docket number 0001 1-01 3US 1, titled “e-Enabler Prescriptive Architecture”, assigned to the same assignee as the present invention.

### FIELD OF THE INVENTION

This invention generally relates to a service-oriented architecture (SOA) in a software project for a user to obtain business process services, and more particularly to a SOA for a user to obtain business process services which are reusable and are composed into multiple processes and composite solutions to support a dynamic business environment.

### BACKGROUND OF THE INVENTION

IT Systems are evolving to be more and more complex as new functionalities and new technologies get added on to the existing service structure. However, several factors have contributed to either lack of progress or a lack of streamlined progress in the system development relating to IT systems. Some such factors include the following: Bad architectural design is an important factor.

Designs hastily done without proper guidance by best practices or proper usage of design patterns contribute to increase refactoring cost at a later time. Known applications not constructed on standards like JSRs (Java specification Requests) from JCPs (Java community Processes) or Open Source® forums end up being re-worked for bug-closures. Another significant negative factor with known applications is the lack of continual build/deploy and testing process to meet a ‘reliable’ delivery.

The consequence of known prior art system-development includes an increased effort and time consumed in every new functionality addition. The prior art approach also leads to an increased support-cost. The foregoing disadvantages need to be addressed.

### SUMMARY OF THE INVENTION

The present invention, herein referred to as e-Enabler framework provides a system and application design paradigm that deploys independent reusable service modules for assisting multiple processes and solutions in a business environment. The e-Enabler Framework developed on e-Enabler prescriptive architecture and powered by Open Source® technology provides a flexible and managed solution to both business and technology. It is a simplified solution to the basic challenges faced during development/construction phase of a SOA (Service Oriented Architecture) based implementation across functional tiers.

Described hereinafter is an e-Enabler Framework in the form of a systems and application design model that leverages independent, self-describing modules of code or “services” that can be reused and composed into multiple processes and composite solutions. The e-Enabler Framework as described herein is a foundation that is geared to support a dynamic business environment.

The services provided by one form of the inventive e-Enabler Framework have standardized, published interfaces for ease of discovery, identification, and consumer use. They can encapsulate independent data-systems, or business-centric functions, and they can be dynamically invoked by other systems and services automatically or upon request.

The basic design principles associated with one form of the present e-Enabler Framework include:

Decentralized, decoupled, modular design: By leveraging virtualized capabilities of e-Enabler framework, a business enterprise can reduce the problems or risks associated with introducing new technologies and information sources into operational environments and increase the types of software and devices that may be utilized.

Autonomous services: Each “service” of the Framework performs a cohesive and well defined set of functions; the services are self-describing and discoverable; and are independent of the platform, data, or process used.

Dynamic service invocation: e-Enabler Framework's ability to route and trigger services in a dynamic fashion utilizing abstracted operational and business rules is a key technological foundation supporting flexible use of services.

“e-Enabler Framework” helps implement Agile® enterprise applications based on the e-Enabler Prescriptive Architecture and enables them to provide SOA services. In one form, it consists of sub-frameworks and utility services, with a set of common infrastructure services that are built on top of the base J2EE Platform.

Reference is made herein to Agile software development. Agile software development is a conceptual framework for undertaking software engineering projects. There are a number of Agile software development methods, such as those espoused by “The Agile Alliance”, a non-profit organization. Most Agile methods attempt to minimize risk by developing software in short time boxes, called iterations, which typically last one to four weeks. Each iteration is like a miniature software project of its own, and includes all of the tasks necessary to release the mini-increment of new functionality: planning, requirements-analysis, design, coding, testing, and documentation.

The present invention in one form resides in a system and application design model that deploys independent self describing reusable service modules for assisting multiple processes and composite solutions in a business environment to provide application management, comprising: a plurality of managed sub-frameworks connected to selectively provide a plurality of infrastructure services based on service oriented architecture and implementation across tiers. The sub-frameworks preferably comprise web-presentation framework, business logic framework, and data access (or persistence) framework. The system might include infrastructure services selectively comprising logging service; security service; notification service; caching service; session management service; internationalization and metrics service; user messages service; reporting service; printing service; and business rule service. At least some of the infrastructure services may be provided selectively by independent data systems and business centric systems which can be invoked by user request or automatically by other systems.

In a second form, the invention resides in a service oriented web architecture for providing managed business services to a user in a dynamic fashion utilizing operational and business rules, the web architecture including multiple processes and composite solutions, comprising: a web presentation framework; business logic framework; and, a data access framework. The frameworks are also referred to herein as tiers.

In a third form, the invention resides in a service oriented software development architecture system for providing managed enterprise business services, comprising a web presentation framework, a business logic framework, and a data access framework, the architecture system including: a system-package structure which is modularized with respect to layers of identified development architecture; an automated transaction capability with a configuration management system for dynamic population of source code packages of the enterprise business services; an automated build-process with a single command to build, test and display said architectural system; an automated quality assurance (QA) process with a single command execution of tests and generation of reports on the system architecture; and, ability for managing environment specific system-package release including functions of QA, testing and production. The web presentation framework may form a presentation tier which is configured for following screen-to screen navigation based on user criteria, and for initiating business-events to be sent to the business logic framework. Further the business logic framework is configured to invoke selected business process functions, and is configured to perform database access through a data access tier.

In a modification, the present inventive Framework might include several reusable plug-in modules that offer different services or functionalities within the framework of the SOA. The plug-in modules may be off-the shelf components thus improving cost-effectiveness. The service oriented architecture in the present invention may be configured to provide business functionality as web services upon demand to a user. The SOA might include interfaces and components to implement a business controller function, business process layer function, and application services layer function. The SOA might further include administrative and management components for gathering performance metrics of transactions in the business logic framework.

### BRIEF DESCRIPTION OF THE DRAWINGS

A more detailed understanding of the invention may be had from the following description of preferred embodiments, given by way of example and to be understood in conjunction with the accompanying drawing wherein:

FIG. 1 illustrates an exemplary e-Enabler Prescriptive Architecture on which the present e-Enabler Framework is based;

FIG. 2 is a diagrammatic representation of an exemplary SOA based e-Enabler Framework;

FIG. 3 illustrates the service bus and a message bus interacting with three functional tiers; and,

FIG. 4 diagrammatically illustrates the modular-build and deploy-management functions as implemented in one application, and shows a detailed breakdown of the modular and sub-modular functions.

### DETAILED DESCRIPTION

In the following detailed description of the various embodiments of the invention, reference is made to the accompanying drawings that form a part hereof, and in which are shown by way of illustration specific embodiments in which the invention may be practiced. These embodiments are described in sufficient detail to enable those skilled in the art to practice the invention, and it is to be understood that other embodiments may be utilized and that changes may be made without departing from the scope of the present invention. The following detailed description is therefore not to be taken in a limiting sense, and the scope of the present invention is defined only by the appended claims and their equivalents.

In retail industry, a user generally tends to utilize the ‘browse and buy’ business process which ideally is an orchestration of the following broad level activities:
a. system authenticating the user,
b. user browsing the catalog,
c. user selecting item from the catalog and placing it in the shopping cart,
d. user checking-out the shopping cart (i.e., placing order),
e. user's order number is generated,
f. user makes payment,
g. the payment modes get validated, and,
h. the ordered item is shipped as per provided details.

For developing the above business process as software, and made part of an enterprise application, the present approach uses a design preferably done in the following manner.

There would be a set of screens which would be at the front-end of the system. Users will put in requests via these screens which would get processed by the system. These user-requests enter the presentation tier first. At this juncture, two main activities happen, i.e., the screen-to-screen navigation is processed based on known criteria, and business events to be sent to the business tier are generated.

The business tier receives the business events, and based on their identifications, would invoke the corresponding business process functions. For example, if the event is “catalog-browse”, the getCatalogDetail( ) functionality of the ‘browse-and-buy’ business process would be executed to retrieve the catalog details. The same is the case for other events also.

Now the business process functionalities like getCatalogDetail( ) may require a database interaction to retrieve the actual catalog information. So the persistence tier (data access tier) would be utilized for such an interaction.

It is noted that the presentation tier would utilize the presentation sub-framework, the business tier would utilize the business logic sub-framework, and the data-access tier would utilize the persistence (or data access) framework to accomplish their goals.

At multiple points of the application transaction, there are situations of infrastructure service utilizations. For example, the presentation tier will invoke the security-authentication service to identify the user credentials.

External service providers (ESPs) have used frameworks, tools and methodologies to accelerate solutions, as known by those skilled in the art.

The term “framework” herein is used to include methodologies, integrated tools, templates and software interfaces that support the design, development, integration and management of SOA-based applications.

SOA-based frameworks offered by ESPs include the following:
Accenture Delivery Suite®,
Avanade Connected Architecture®,
BearingPoint® Real Time Enterprise Framework,
EDS Agile Enterprise®,
Hewlett-Packard (HP) Adaptive Enterprise®,
IBM® Component Business Model, and,
Unisys 3-D Visible Enterprise®.

The present e-Enabler Solution Kit's Prescriptive Architecture provides for achieving agility of the architectural model by coupling each of the layers along with business-coherence among all of the layers. The e-Enabler solution Kit's Prescriptive Architecture in one form addresses the question of achieving agility by mapping to the following tenets of architecture:
Business relationship grid,
Business processes and styles,
Patterns, and,
Bricks.
   The design center for the ESPs' framework should expediently focus on the business process. The framework should support methods and tools to analyze and deconstruct business processes into reusable common services, as the present invention aims to do.

Two categories of methodologies in the context of the present invention improve agility and reuse in SOA-based environments, for example, as described below:
a) Architected Model-Driven (AMD) methodologies require the organization to have a high degree of maturity with regard to IT governance and artifact reuse and is more scalable to support an entire enterprise. If the ESPs' framework includes the following, it most likely uses an AMD approach:
   Pre-built business object models, and,
   Model-driven code generators.
b) Architected Rapid Application Development (ARAD) is suitable for solutions involving a moderate degree of change and complexity. It is the most appropriate choice when the focus is on the reuse of technical architectures (patterns and bricks) to balance time to solution, cost and quality in, for example, a Java 2, J2EE or .Net Platform. If the ESPs' framework involves the following, it most likely is using an ARAD approach:
   OO/UML or business process analysis (BPA) modeling.
   Extensive application code generation.
   Generated workflow specifications for business process management software from UML or BPA models.

### The present Framework also practices the tenets of “good-enough” architecture, minimizes lock-in, and addresses mechanisms for reuse.

In one form, the e-Enabler Framework comprises the following sub-frameworks:
Web Presentation Framework,
Business Logic Framework, and,
Persistence (Data Access) Framework

As described herein, the e-Enabler Framework provides a multiplicity of infrastructure services. The following are exemplary infrastructure services and their corresponding technologies in one form of the e-Enabler Framework:

| | |
|---|---|
| Logging Service | log4j-1.2.8 |
| Security Service | JAAS, jakarta-oro-2.0.7 |
| Notification Service | JMS (Java Messaging Service) |
| Caching Service | java cache service (JCS) |
| Session Management Service | java cache service (JCS) |
| Internationalization Service | java API's |
| Metrics Service | Application Response |
| | Measurement (arm 3.0) |
| User messages Service | Jakarta poi-2.0-RC2 |
| Reporting Service | Jasper Reports |
| Printing Service | jdk 1.4 Printing API |
| Business Rule Service | Blaze Advisor (FairIzac), JRules |
| | (iLog), Drools |

Service buses form part of the infrastructure in the present e-Enabler Framework, and, in one embodiment, the service bus of the e-Enabler Framework includes the following two components:
1. Common Invocation Framework, which assists in helping in dynamic discovery of services, by way of looking up a registry, identifying the location of services and invoking the relevant service components; and,
2. Message Broker, which can be in the form of a communication channel facilitating asynchronous and synchronous communication between service consumers and service providers.

The e-Enabler Framework in a preferred form also includes a plurality of plug-in modules for performing different functions. In one form, the invention uses six plug-ins which include:
Spring Framework—This plug-in is used for harnessing the benefits of Spring framework's Inversion of Control capabilities.
Hibernate—This plug-in is used for implementing Object-Relationship mapping on an Open-Source® platform.
Toplink—This plug-in is used for implementing Object-Relationship mapping on Oracle® platform.
jBPM—This plug-in is used for implementing business process management on an Open-Source® platform.
Mule—This plug-in is used for implementing Enterprise Service Bus capabilities on an Open-Source® platform.
Axis—This plug-in is used for converting standalone Java® based services to web-services on an Open-Source® platform.

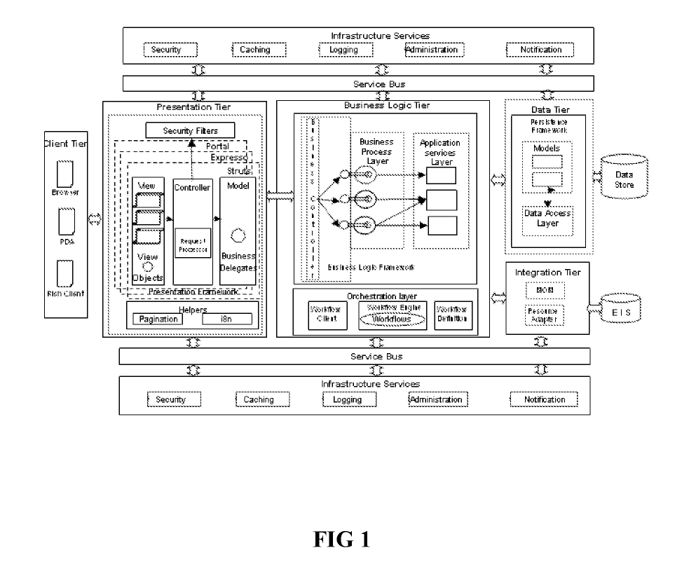

One embodiment of the present invention uses five tiers which have known functions and interacting abilities. With specific reference to FIG. 1, the following is an overview of the functionality of the five tiers and their interaction, in one embodiment of the system:
1. Web Client Tier: This tier includes the components required by the end-user to interact with the web application using varied inputs.
2. Presentation Tier: This tier would have the presentation logic for rule based navigation across web pages. The presentation logic would also provide infrastructure service support including security, caching, server side request validation, etc.
   The presentation tier for example, may use the following industry-best-practice design patterns:
1. Model-View-Controller,
   Benefits: To decouple business state representation, application management, and presentation,
2. Front Controller,
   Benefits: To centralize and manage application request processing, and,
3. Business Delegate,
   Benefits: To reduce coupling between Web and EJB tiers as per GRASP patterns,
4. Intercepting Filter,
   Benefits: Apply configurable pre & post processing of requests & responses, and,
5. Service Locator,
   Benefits: To abstract and encapsulate service lookup details (& provide caching).

### The Presentation Tier ensures formation of business requests and receipt of business responses for every transaction and proper delegation of the requests to the business-logic tier via a generic business delegate implementation.

### 3. Business Tier

The business requests generated from the Presentation Service layer would be managed by the Business Controller {Business requests are mapped to Business request Handlers which in turn would invoke the business process services (Facades)}.

The Business Logic Tier has the following layers to capture the application business processes:
Business Process Layer
   This layer implements the Session Facade design pattern in order to coordinate operations between multiple business objects. This layer would have the business process services (identified functional services) componentized to have the logical flow of the constituent functional steps that need to be performed to provide a business function.
Application Services Layer
   This layer would provide a well-defined application-specific discrete function that can exist independently. The services in this layer would not have any business process knowledge. They would consist of the logic pertaining to each of the functional steps that constitute the business process.

### 4. Data Tier

This tier would have the data access logic to interact with the underlying data stores. This tier would have Data Models which represent the data entities as objects and Data Access layer which would encapsulate the details of connecting the data-models to the underlying data store. This tier would use the DAO (Data Access Object) design pattern to abstract and encapsulate data access mechanisms.

### 5. Integration Tier

This tier provides the services needed for the system to interface with external systems. For example, JCA® (Java Connection Architecture) Adaptors and a Message Oriented Middleware may be used in this tier to interface with external systems.

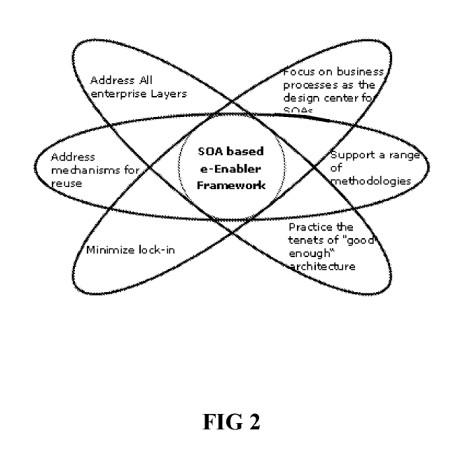

FIG. 2 illustrates a pictorial view of an SOA based e-Enabler Framework, which includes the following functionalities: address all enterprise layers; focus on business processes as the design center for SOAs; support a range of methodologies; practice the tenets of “good enough” architecture; minimize lock-in; and address mechanisms for reuse. The Framework might allow the user to pursue the foregoing functionalities in any order or even selectively simultaneously.

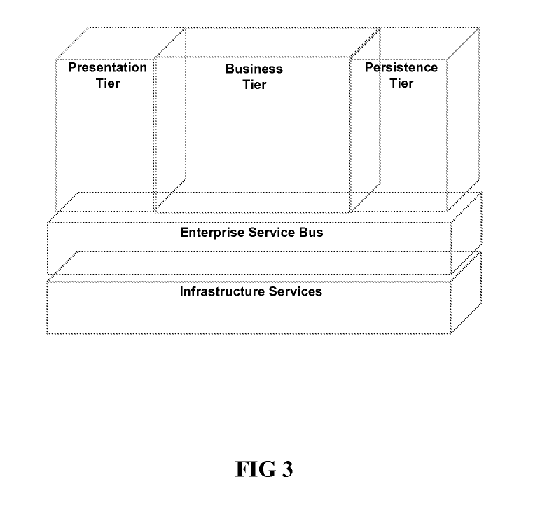

FIG. 3 illustrates a pictorial view of the interaction of the three tiers, i.e., presentation tier, business tier and persistence (data access) tier, with the enterprise service bus and the infrastructure services.

The application is connected to the 3 sub-frameworks, i.e., presentation framework, business framework and persistence (data access) framework referred to above. This application would also require enterprise services to implement a mission critical system. For e.g., caching (storing information that is retrieved repeatedly at a temporary store to save round-trip time), logging (capturing transaction details on a file), security-authentication (identifying a user), security-authorization (providing necessary permissions to identified users) etc. are some of the e-Enabler infrastructure services which will be used by the application at a given point during a transaction.

It is noted that for any enterprise application implementation, all the services are required.

With specific reference to FIG. 3, the three sub-frameworks are expediently placed at each of the following tiers;
Presentation Tier—Web Presentation sub-framework—The presentation logic resides here.
Business Tier—Business logic sub-framework—The business process logic resides here.
Persistence Tier—Persistence sub-framework—The data access related logic resides here.
   The application will sit on top of these frameworks and would utilize the infrastructure services by requesting the services from the enterprise service bus (ESB) shown in FIG. 3. The ESB will provide a registry to have the services registered thereon and would facilitate routing of the request calls. The infrastructure service invocation can be initiated from any tier.

The development of sub-frameworks is guided by preferred requirements as follows:

Web Presentation Framework

The web presentation framework is designed to address the following presentation tier requirements.
1. The system needs to provide a UI (User Interface) for clients accessing it using the internet.
2. The framework should be able to support development of UI for multiple delivery channels like PDAs, etc., in future.
3. The framework should provide mechanisms to develop UI with a consistent look & feel that should be template-based and configurable from one place.
4. The screen flow (navigation) should be configurable.
5. The framework should provide for efficient validation of data submitted by the user both on the client side and on the server side.
6. The framework should provide a proper error handling mechanism for request processing.
7. The framework should provide support for developing screens requiring modifications.
8. There should be controlled access to functionality based on permissions.
9. There should be capability to support users from multiple geographical locations.
10. The framework should provide a mechanism to cache pages partially & in full
11. The framework should provide mechanisms to gather performance metrics of the transactions in the presentation tier
12. The framework should be highly flexible and extensible. For instance,
   The system should allow for changes in the screen flow logic without major rework.
   The system should allow for changes in the business logic without major rework in the presentation tier.
   The system should allow for changes in data requirements and representations in the back-end systems without major rework in the presentation tier.
   The framework should be extensible to accommodate new requirements in the future which are not foreseen now.
   The framework should allow customizations using plug-in modules wherever appropriate.
   The framework should be modular so that the modules providing features not required for a particular scenario can be plugged out.
   The framework should be extensible to expose the business functionality as web services.

Business Logic Framework

The business logic framework will provide the interfaces and base components to help in the implementation of the business logic tier.

This framework will address the following requirements:
Provide a business event-based mechanism to interface with the business logic tier.
Provide the interfaces and components needed to implement the business controller, the business process layer and the Application services Layer.
Provide the administration & management components to gather performance metrics of the transactions in this tier.
Provide declarative functional entitlement at the various layers.

Data Access (or Persistence) Framework

The persistence framework is designed to address the following requirements of the persistence tier:
Ability to provide configurable mapping of the java objects to the data store representations.
Ability to handle object relations & dependencies without having to write a lot of code.
Ability to cache the data.

Interaction Between the Sub-Frameworks:

The user inputs his requirements on the screen and submits a form. The system-control moves to the web-presentation framework. Broadly two activities happen at this juncture.
Screen-flow navigation—i.e., control navigation from one screen to another based on relevant user provided parameters.
Generating business events to trigger corresponding business processes as part of the next tier i.e., business logic tier.

### As part of the above processing there are requirements for using enterprise capabilities such as caching, security (authentication, access control), and internationalization etc which may be obtained by utilizing the infrastructure services.

The business events generated in the presentation tier are preferably handled by event handlers at the business-logic sub-framework. These event handlers invoke respective business processes based on the events.

The business processes accomplish the required task by orchestrating several functionalities involved. During orchestration, the business processes may interact with databases using the persistence (or data access) framework.

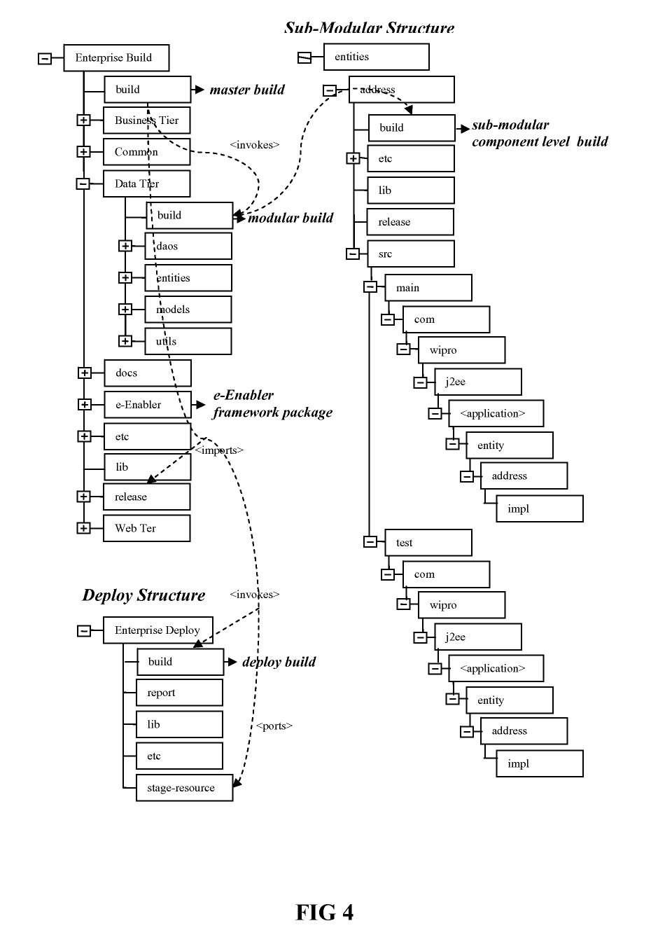

FIG. 4 pictorially illustrates a Master and Modular Build Function in one application of the invention. With specific reference to FIG. 4, the following provides a detailed explanation of the Application Master, the Modular Structure and the Sub-modular Structure.

When an application is developed, the corresponding codebase is kept in a set of dedicated folders or packages for better maintenance, understanding and management. The enterprise application should preferably consist of multiple modules as part of its business processes. These modules might have sub-modules as part of the functionality.

The enterprise application is expediently developed by a team which can be very large in size with specific developers developing components under identified module leads. Ideally, this enterprise package structure would be designed in such a manner that the activities of developers, module leads and Configuration Managers would be executed in a completely segregated manner. It is noted that preferably, the package structure should also adhere to the architecture of the application.

Complete Application Management (CAM):

e-Enabler framework also provides Complete Application Management that ensures:
A simplified distributed application management model based on distributed Agile.
Separation-of-concern during development process by providing a ready-to-use OTS package structure based on the e-Enabler Prescriptive Architecture.
Continuous integration by a ‘single-click’ automated build and deploy to multiple environments.

With further reference to FIG. 4, CAM is a software development practice, from a Solution Kit relating to e-Enabler Framework, which not only facilitates Continuous Integration but also implements a segregation of responsibility with respect to modules/sub-systems. CAM implements specific ‘build and deploy’ management at each level of the enterprise package structure.

Each integration at enterprise level ensures correct integration at modular, sub-modular and component levels and is verified by a set of automated build and deploys scripts (including tests) to detect integration errors as quickly as possible. Many teams find that this approach leads to significantly reduced integration problems and allows large teams with distributed resources to develop cohesive software more rapidly.

It is noted that CAM addresses several requirements in providing business solutions for a user. The requirements addressed by CAM include:
A package structure for the enterprise application modularized with respect to the layers of identified development architecture,
An automated transaction with configuration management system for dynamic population/updating of source code packages of the enterprise,
An automated build process with a single command to build, test and deploy the system from the sources,
An automated QA (Quality Assurance) process with a single command execution of a suite of tests, and generation of reports on the system,
An automated generation of system-specific documentation, and,
Managing environment-specific system-package release—QA, Testing, Production.

### The master-build scripts of Enterprise_Build manages modular builds and executes deploy-management either locally or remotely.

The following is noted as part of the Complete Application Management process with specific reference to FIG. 4:
A build and deploy package structure for the enterprise application is identified and developed utilizing the Off-The-Shelf structure from e-Enabler repertoire.
The build package structure is modularized and componentized with respect to the layers of finalized development architecture.
The build-scripts are created at respective levels like master/enterprise build scripts residing at the enterprise build folder, modular ones residing at module specific build folders and similar arrangement for sub-modular and component level. All these scripts are expediently developed with minor customization of the existing scripts of e-Enabler repository.
As part of the component build which is normally executed by developers, a set of common steps occur chronologically in an automated manner.
   Automated transaction with configuration management system for dynamic population/updating of source code packages of the enterprise application,
   Compilation of the checked-out source code,
   Temporary packaging of the compiled files,
   Generation of complete documentation for the compiled components,
   Execution of a suite of unit tests on the compiled components at local environment, and,
   Generation of reports for the unit test case execution.

Similar component-builds are invoked by sub-modular builds, which then are invoked by modular-builds, and this process continues till the enterprise build level. Thus a state is reached where a single command triggers an automated build process accomplishing building and QA testing of the entire application.

After building the application, the enterprise build ports the released packages to the stage-resource location of the deploy structure and invokes the deploy-build script. This deploy-build script picks up the packages from the stage-resource location and deploys them to the target environment chronologically.

In a more generic view, the following list summarizes the key issues that are addressed by using the described form of the e-Enabler Framework:
Cost savings and efficiency: By leveraging and reusing existing assets and streamlining processes, an e-Enabler framework based implementation not only can save direct development costs but also can have a tremendous impact on minimizing efforts for ongoing maintenance.
Innovation: The ability to add or change smaller modules of work that will effectively interoperate within existing processes can allow organizations to focus work efforts toward core and differentiating values and help accelerate the introduction of new products and services.
Governance: The abstracted capabilities to handle security, monitoring, and management utilizing the infrastructure services of the e-Enabler framework can provide an ideal foundation to apply and administer rules and oversight effectively across the enterprise and all its business processes.
Response: Performance has always been an area of concern to the application implementation along with other QoS factors. It is noted that special task forces and specific performance tuning exercises preferably get re-estimated.

The present e-Enabler framework in one form has addressed the performance issue by having:
Optimized caching services
Business Logic framework for high volume request management
Optimized service locators
Optimized Persistence framework

TCO (Total Cost of Ownership): The complete TCO equation includes the cost associated with the difficult areas recognized in the SDLC (Solutions Development Life Cycle). The difficult areas result in waste of project time, money, and cause unnecessary aggravation.
e-Enabler framework with e-Enabler prescriptive architecture helps in mitigating the above. The TCO may be computed as below:

$$TCO = cost of effort for architecting on component based model + cost of effort for designing application package structure + cost of effort for auto build and deploy of application + cost of effort in enabling application to SOA .$$

The e-Enabler Framework is currently being used for implementation on the following platforms:
BEA®
Weblogic Application Server
Weblogic Portal
IBM®
Websphere Application Server
Websphere Portal
SAP®
Web Application Server
Netweaver Portal
JBoss® Application Server
Oracle® Application Server
ATG® Application Server
SUN® Application Server.

### It is conceivable that the present e-Enabler Framework can be effectively used on other platforms as well.

In the foregoing detailed description of embodiments of the invention, various features are grouped together in a single exemplary embodiment for the purpose of streamlining the disclosure. This method of disclosure is not to be interpreted as reflecting an intention that the claimed embodiments of the invention require more features than are expressly recited in each claim. Rather, as the following claims reflect, inventive subject matter lies in less than all features of a single disclosed embodiment. Thus the following claims are hereby incorporated into the detailed description of embodiments of the invention, with each claim standing on its own as a separate embodiment. It is understood that the above description is intended to be illustrative, and not restrictive. It is intended to cover all alternatives, modifications and equivalents as may be included within the spirit and scope of the invention as defined in the appended claims. Many other embodiments will be apparent to those of skill in the art upon reviewing the above description. The scope of the invention should therefore be determined with reference to the appended claims, along with the full scope of equivalents to which such claims are entitled. In the appended claims, the terms “including” and “in which” are used as the plain-English equivalents of the respective terms “comprising” and “wherein,” respectively. Moreover, the terms “first,” “second,” and “third,” etc., where present, are used merely as labels, and are not intended to impose numerical requirements on their objects.

1. A system and application design model that deploys independent self describing reusable service modules for assisting multiple processes and composite solutions in a business environment to provide application management, comprising:
a plurality of managed sub-frameworks connected to selectively provide a plurality of infrastructure services based on service oriented architecture and implementation across a plurality of tiers.

2. The system and application design model as in claim 1, wherein said sub-frameworks comprise web-presentation framework, business logic framework, and data access framework.

3. The system and application design model as in claim 2, wherein said infrastructure services selectively include logging service; security service; notification service; caching service; session management service; internationalization and metrics service; user messages service; reporting service; printing service; and business rule service.

4. The system and application design model as in claim 3, wherein at least some of said infrastructure services are provided by commercially available reusable plug-in modules.

5. The system and application design model as in claim 3, including a service bus comprising a common invocation framework bus and a message bus.

6. The system and application design model as in claim 3, wherein at least some of said infrastructure services are provided selectively by independent data systems and business centric systems which can be invoked by user request or automatically by other systems.

7. The system and application design model as in claim 1, configured to provide caching services and service locators, and to provide interaction with a business logic framework and a data access framework.

8. A service oriented web architecture for providing managed business services to a user in a dynamic fashion utilizing operational and business rules, said architecture including multiple processes and composite solutions, comprising:
a web presentation framework;
a business logic framework; and,
a data access framework.

9. The service oriented architecture as in claim 8, wherein the web presentation framework includes a UT (User Interface) for client access to internet facilities.

10. The service oriented architecture as in claim 9, wherein the UT is configured to have controlled access based on authorization and verification.

11. The service oriented architecture as in claim 10, configured to support users from multiple international locations.

12. The service oriented architecture as in claim 8, configured to provide business functionality as web services upon demand to a user.

13. The service oriented architecture as in claim 8, including interfaces and components to implement a business controller function, business process layer function, and application services layer function.

14. The service oriented architecture as in claim 13, including administrative and management components for gathering performance metrics of transactions in said business logic framework.

15. The service oriented architecture as in claim 8 wherein the data access framework includes data-caching ability.

16. The service oriented architecture as in claim 8, which is configured to perform
a) screen flow navigation comprising moving of screen-control from one screen to a next screen based on user-provided parameters, and,
b) generation of business events to trigger business processes as part of a business logic tier.

17. The service oriented architecture as in claim 8 including an enterprise service bus and an infrastructure service bus connected to and interacting with said web presentation framework, said business logic framework and said data access framework.

18. The service oriented architecture as in claim 8 wherein, when an enterprise application is developed by a user, its corresponding code base is kept in folders, wherein said enterprise application comprises multiple modules as part of a business process.

19. The service oriented architecture as in claim 18 wherein at least one of said multiple modules comprises sub-modules.

20. A service oriented software development architecture system for providing managed enterprise business services, comprising a web presentation framework, a business logic framework, and a data access framework, said architecture including:
a system package structure which is modularized with respect to layers of identified development architecture;
an automated transaction capability with a configuration with a configuration management system for dynamic population of source code packages of said enterprise business services;
an automated build-process with a single command to build, test and display said architectural system;
an automated quality assurance (QA) process with a single command execution of tests and generation of reports on the system architecture; and,
and ability for managing environment specific system-package release including functions of QA, testing and production.

21. The service oriented architecture as in claim 20, wherein said web presentation framework forms a presentation tier which is configured for following screen-to screen navigation based on user criteria, and for initiating business-events to be sent to said business logic framework, further wherein the business logic framework is configured to invoke selected business process functions, and is configured to perform database access through a data access tier.
